(19) United States
(12) Patent Application Publication
(10) Pub. No.: US 2025/0307612 A1
(43) Pub. Date: Oct. 2, 2025

(54) PERSONALIZED DATA ASSISTANT

(71) Applicant: Amazon Technologies, Inc., Seattle, WA (US)

(72) Inventors: Joshua Kulas, Washington, DC (US); Shiro Ushijima, Belmont, MA (US); Brannon Mason, Arlington, VA (US); Maxim Petrenko, Bellevue, WA (US)

(21) Appl. No.: 18/622,097

(22) Filed: Mar. 29, 2024

(51) Int. Cl. G06N 3/0455

(52) U.S. Cl. CPC G06N 3/0455

(57) ABSTRACT

A system may receive a request to generate a solution plan. The system may obtain user information, and/or environment information based in part on the request. The system may determine, based at least in part on the user information, a persona corresponding the user. The system may generate, based at least in part on the request, the user information, the environment information, and/or the persona, a solution generation prompt configured to cause a machine learning model to generate a personalized solution plan. The system may generate the personalized solution plan based on applying the solution generation prompt as input to the machine learning model.

### BACKGROUND

Computing systems can receive requests for instructions to solve a problem, or perform an action, and provide instructions in the form of a solution. In some implementations, a computing system, which may be referred to as a solution provider system, may receive a request from a requesting device. The solution provider system may then identify a solution from an existing repository of solutions and provide the solution to the requesting device.

### BRIEF DESCRIPTION OF THE DRAWINGS

Embodiments of various inventive features will now be described with reference to the following drawings. Throughout the drawings, reference numbers may be re-used to indicate correspondence between referenced elements. The drawings are provided to illustrate example embodiments described herein and are not intended to limit the scope of the disclosure. To easily identify the discussion of any particular element or act, the most significant digit(s) in a reference number typically refers to the figure number in which that element is first introduced.

FIG. 1 is a block diagram of an environment providing a personalized assistance system according to some embodiments.

FIG. 2 is a block diagram of illustrative data flows within an environment providing a personalized assistance system according to some embodiments.

FIG. 3 is a flow diagram of an illustrative routine for generating a prompt for a personalized assistance system according to some embodiments.

FIG. 4 is a flow diagram of an illustrative routine for generating a personalized response according to some embodiments.

FIG. 5 is a block diagram of an illustrative computing system configured to generate personalized solution information according to some embodiments.

### DETAILED DESCRIPTION

The present disclosure relates to the generation of a solution plan in response to a request received from a user. The solution plan may be personalized for the user, for example, based on a persona determined by a system to represent the user identity.

Some conventional systems allow for the retrieval of an existing solution plan from a set of existing solution plans, where each solution plan of the set of solution plans is generally configured to allow a user to perform an action or otherwise solve an issue (e.g., repairing an equipment failure, locating a piece of equipment, operating a device, etc.). However, such existing solution plans may present various challenges for a user. For example, an existing solution plan may have been created by an individual with significant experience solving the issue associated with the solution plan. In such a case, the existing solution plan may be challenging for the requesting user to understand or interpret. This may lead the user to performing an action in the solution plan incorrectly, which may cause further harm. Additionally, difficulty in understanding or interpreting the solution plan may cause the user to take time reviewing outside materials to gain a better understanding of the solution plan. This may lead to an issue remaining unresolved for extended periods of time, reducing overall productivity of the user, and potentially reducing the functioning of the environment in which the user is attempting to correct the issue.

Additional conventional systems may allow for the generation, for example by a machine learning model, of a solution plan to address an issue. The machine learning model may be configured to access stored information, such as user manuals or maintenance logs, and provide relevant portions of the stored information in the form of a solution plan to the user. However, the user manuals and maintenance logs may include inconsistent terminology, or terminology which is not clear to the user based on, for example, the user's experience level in a job. This may lead to similar issues as discussed in relation to other conventional systems above, where the user is unable to correctly implement or understand the solution plan.

Some aspects of the present disclosure address some or all of the issues noted above, among others, by generating a personalized solution plan for a user based in part on determining a persona for the user. The personalized solution plan may include a plurality of solution instructions, where each instruction may direct the user in achieving a portion of an overall solution to an issue indicated in the user's request for assistance. For example, a system of the present disclosure may receive a request from a user device to provide a solution plan which will solve an issue. The request may be provided in natural language, and in some cases may include search terms (e.g., Boolean search terms, SQL commands, pseudocode describing a search, and the like). Additionally, the request may include media, for example images, which may be used to further assist in the identification of the cause of an issue associated with the request (e.g., an equipment malfunction, a request for assistance using a device, etc.). Advantageously, because the present disclosure allows for the processing of natural language requests, a user is not required to be familiar with database searching, or any query style or language, in order to receive a useful response.

The solution plan may also be presented to the requesting user in natural language. Additionally, the solution plan may include various media types such as images, structured text, video, audio, or multimedia components, where such media types may be useful to aid in the understanding of the solution plan instructions or ability of the user to implement the solution plan. Such media may be generated by a machine learning model or may be retrieved from existing sources stored in a location accessible to the system generating the solution plan. Further, where the solution plan is generated from materials using different terminology for a same object or concept (e.g., a technical manual from a manufacturer of a device and a maintenance log written by an engineer employed by a company where the device is used), the machine learning model may harmonize the terminology, or replace technical concepts with simpler terminology, so that the solution plan is internally consistent in its description of the solution plan. The solution plan may be presented as a single solution plan, or may be presented as a plurality of solution instructions. Where the solution plan is presented as a plurality of solution instructions, the solution instructions may be, for example, an ordered list of actions which, when completed by the user, are expected to solve the issue in the user's request.

The persona may generally represent the user as part of a class or group of similar users. Where the persona represents a group of similar users, the grouping may be generated by a computing system, and the grouping may not be interpretable by a human (e.g., the grouping may be generated and interpretable by a machine learning model). In some embodiments, the persona may correspond to a more generalized grouping or class of users which is based on specific or individualized information corresponding to each user. In some embodiments, the persona represents a group or class of users that share a common attribute, characteristic, or role information. For example, a persona may be generated based on determining an experience level of a user, a current job of a user, a seniority of a user, and the like. The persona, as used herein to generate a personalized solution plan, may comprise indicators of various pieces of information associated with the user which may enable the solution plan to be more understandable by the user than a solution plan generated by conventional systems. For example, a machine learning model may receive the persona as input along with, or as part of, a prompt to generate the solution plan. The machine learning model may use the persona to determine, for example, a terminology used by the requesting user, a level of skill of the user to which the solution plan may be drafted, additional information to include in the solution plan, a modality (e.g., text, image, video, audio, etc.) for at least a portion of the solution plan best suited to the user, and the like. The personalized assistance system may store generated personas in a storage location. The personalized assistance system may then retrieve a previously generated persona instead of generating a new persona when a user is determined to be similar to an existing persona. This may reduce the time required to generate a personalized solution plan.

For example, a user may be an employee of an employer which operates a manufacturing environment. A computing device (e.g., a handheld computing device) may be provided to the user by the employer, or otherwise be associated with the user. The user may then enter a request, in natural language, into a user interface presented by the computing device. In some embodiments, the request may further include images, video, audio, and/or other modalities of information, provided by the user through the computing device. The request may include details at varying levels of specificity. For example, the request may indicate that equipment in an area of an employment facility is making a strange noise, and may include an indication of the area in which the noise is being heard (e.g., based on device information for a device from which the request was transmitted). Alternatively, the request may indicate a specific machine is overheating when used in a specific way.

The request may then be received by a personalized assistance system from the computing device. The personalized assistance system may retrieve information about the user's employment, for example a user's job title, user's length of employment, and the like. Additional user information may be retrieved when such information is voluntarily provided by the user for use with the personalized assistance system, such as an educational history or past employment experience. The personalized assistance system may further retrieve additional environmental information or contextual information for an environment in which the user is active which may be useful in generating a personalized solution plan. For example, the personalized assistance system may retrieve spatial information for the environment, a time of year, a time of day, and the like. In some embodiments, some or all of the previously described information may be provided by the user via the user interface of the computing device. The personalized assistance system may then generate a prompt for a machine learning model based on the retrieved, or received, information. The prompt may be configured to cause the machine learning model to generate a personalized solution plan. The personalized assistance system may apply the prompt as an input to the machine learning model, causing the machine learning model to generate the personalized solution plan. When the machine learning model has generated the personalized solution plan, the personalized assistance system may transmit the solution plan to the computing device, causing the computing device to present the solution plan to the user.

In some embodiments, the prompt may be configured to cause the machine learning model to generate a solution plan which is not personalized. In such embodiments, the personalized assistance system may then apply obtained information (e.g., retrieved or received information) associated with the user, context, or environment as part of a prompt to a second machine learning model configured to personalize an existing solution plan. For example, the second machine learning model may replace terminology, add additional steps, remove steps, or otherwise modify the existing solution plan to be a personalized solution plan for the user.

The term “model,” as used in the present disclosure, can include any computer-based models of any type and of any level of complexity, such as any type of sequential, functional, or concurrent model. Models can further include various types of computational models, such as, for example, artificial neural networks (“NN”), language models (e.g., large language models (“LLMs”)), artificial intelligence (“AI”) models, machine learning (“ML”) models, multimodal models (e.g., models or combinations of models that can accept inputs of multiple modalities, such as images and text), and/or the like.

Various aspects of the disclosure will be described with regard to certain examples and embodiments, which are intended to illustrate but not limit the disclosure. Although aspects of some embodiments described in the disclosure will focus, for the purpose of illustration, on particular examples of users, environments, and the like, the examples are illustrative only and are not intended to be limiting. In some embodiments, the techniques described herein may be applied to additional or alternative types of users, environments, and the like. Additionally, any feature used in any embodiment described herein may be used in any combination with any other feature or in any other embodiment, without limitation.

### Example Personalized Assistance Environments

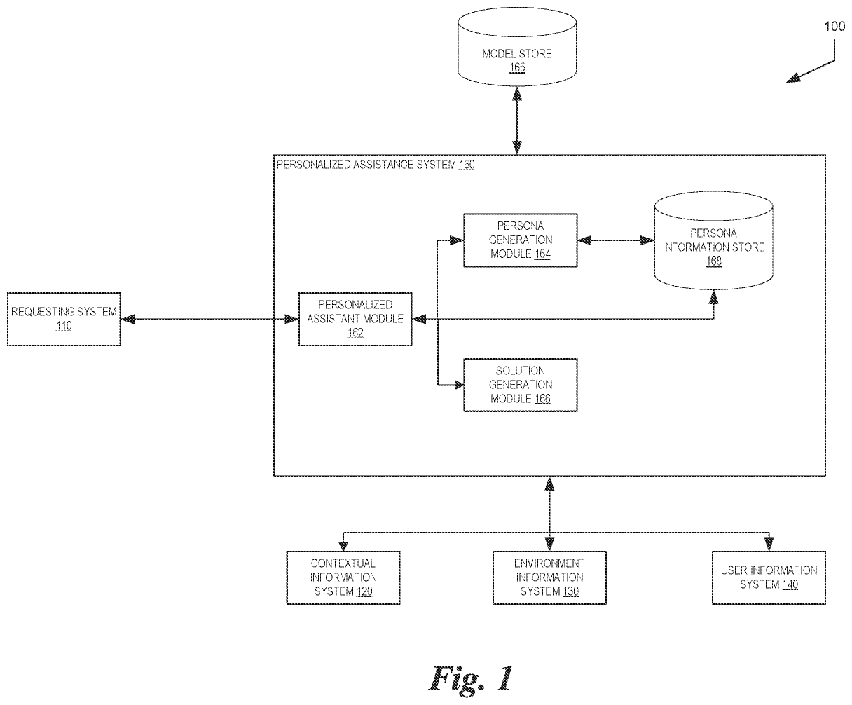

With reference to an illustrative example, FIG. 1 shows an environment 100 for a personalized assistance system 160. The environment 100 includes a requesting system 110, a personalized assistance system 160, a model store 165, a contextual information system 120, an environment information system 130, and a user information system 140.

The requesting system 110 may be a computing system configured to receive requests from a user. For example, the requesting system 110 may provide an interactive graphical user interface (GUI) through which the user may provide a user request. The GUI may be configured to accept text, audio, and/or other forms of input as part of the user request. Additionally, the GUI may be configured to present a response to the user request. The response may include text, audio, video, and/or other types of media useful for instructing the user to implement a solution generated by the person alized assistance system 160.

The personalized assistance system 160 is a computing system configured to provide a response, such as an answer or solution generated in response to a request from a user. The response may be personalized for the user, for example based on a persona determined to be associated with the user and/or based on information associated with the user. The personalized assistance system 160 may comprise a personalized assistant module 162, a persona generation module 164, a persona information store 168, and a solution generation module 166. The personalized assistance system 160 is in communication with a model store 165, from which one or more machine learning models may be retrieved, and used by the personalized assistance system 160, to generate a solution plan.

The personalized assistant module 162 is a part of the personalized assistance system 160 configured to receive a request from a requesting system 110 to generate a response. The personalized assistant module 162 is further configured to manage additional elements of the personalized assistance system 160 to enable the generation of the response. When a request is received by the personalized assistance system 160, the personalized assistant module 162 may transmit a persona generation request to the persona generation module 164. The persona generation request may be based, at least in part, on the request received by and/or from the requesting system 110. For example, the persona generation request may include an identifier associated with the requesting system 110 used to identify the user who generated the request. The personalized assistant module 162 may receive, from the persona generation module 164 in response to the persona generation request, the generated or obtained persona information.

Additionally, based on the user request, the personalized assistant module 162 may retrieve user-specific information from the user information system 140 which may be useful for generating a personalized solution for the user. As described in further detail below, user information stored by the user information system 140 which may be considered personal information is accessible when the user associated with the user information has provided voluntary informed consent to make such user information accessible to the personalized assistance system 160. The personalized assistant module 162 may then generate a prompt to be provided to a machine learning model to cause generation of a personalized solution. The prompt may include at least a portion of the persona information and user information retrieved or generated by the personalized assistant module 162 and persona generation module 164. In some embodiments, the persona information or user information may not be directly included, and instead an indication may be included in the prompt that such information is to be accessed by the machine learning model, for example from the user information system 140 or the persona information store 168, during generation of the solution. In some embodiments, the personalized assistant module 162 may generate a prompt using a rules-based system for constructing the prompt. Alternatively, the personalized assistant module 162 may use a machine learning model to generate the prompt.

The persona generation module 164 is configured to generate persona information associated with a user of a requesting system 110 from which the personalized assistance system 160 receives a user request. The persona generation module 164 may receive at least a portion of the user request from the personalized assistant module 162, for example a portion of the user request identifying a user associated with the requesting system 110. For example, the requesting system 110 may have a device identifier (e.g., a MAC address, an IP address, etc.), and the device identifier may be associated with one or more users in a data store (e.g., the user information system 140). The persona generation module 164 may retrieve additional user information associated with the user. For example, the persona generation module 164 may retrieve user information indicating a current job title, a past job title, a length of employment, terminology associated with the user (e.g., a list of words common to the user's job), or previous requests received from users with a similar profile to the requesting user. As described in further detail below with respect to the user information system 140, users may additionally choose to provide further information to the personalized assistance system 160, for example an educational history, an indication of languages spoken, a previous employment history, etc.

When the persona generation module 164 has retrieved or obtained information related to the requesting user, the persona generation module 164 may generate a portion of a prompt for a machine learning model including at least a portion of the retrieved or obtained persona information. For example, to generate the portion of the prompt, the persona generation module 164 may combine obtained information related to the user's job with instructions to access a storage location storing previous similar requests from users associated with a similar persona to the requesting user's. Alternatively, the persona generation module 164 may provide the retrieved persona information to the personalized assistant module 162 so that the personalized assistant module 162 may generate the prompt for the machine learning model. Additionally, the persona generation module 164 may store retrieved or generated persona information in the persona information store 168 for later retrieval and use. For example, when a request is received by the persona generation module 164, the personalized assistant module 162 may search the persona information store 168 for previously generated personas which may match a profile of the requesting user.

The solution generation module 166 is configured to generate a solution plan to be enacted by a user. The solution generation module 166 may generate the solution plan in response to a prompt generated by the personalized assistant module 162. The solution generation module 166 may generate the solution plan based on at least a portion of the persona information and the user information included in the prompt. Further, the solution generation module 166 may access additional systems to retrieve information for use in generating the solution plan. For example, the solution generation module 166 may retrieve information from the user information system 140, environment information system 130, or contextual information system 120 as part of the process of generating the solution. The solution generation module 166 may generate the solution plan using a machine learning model, for example a machine learning model stored in the model store 165. In some embodiments, the ability of the solution generation module 166 to access information sources (e.g., environment information system 130, contextual information system 120, etc.) may be determined based at least in part on the persona associated with the user. For example, a persona indicating the user is associated with a management level job position may be used to determine the solution generation module 166 is allowed to access a secure information storage location associated with the user's employer to generate a solution plan, whereas a persona indicating the user is associated with a non-management level position may be used to determine the solution generation module 166 is not to access the secure information storage location to generate the solution plan.

In some embodiments, the solution generation module 166 may generate the solution plan in a plurality of solution generation stages. Each solution generation stage may result in the generation of a portion of the solution plan. The solution generation module 166 may continue to generate portions of the solution plan until the solution generation module 166 has determined that the solution plan may be responsive to the request received from the requesting system 110. For example, if the request is for information on replacing a battery in a device, the solution generation module 166 may continue to repeat a solution generation stage to generate portions of the solution plan until the solution plan includes instructions for accessing a battery compartment of the device, replacing the battery, restoring the device to a working condition, and testing the device to determine whether the replacement battery is correctly installed.

In some embodiments, the solution generation module 166 may incorporate information about the user, and/or the user persona, during the solution generation process. For example, during each solution generation stage, the solution generation module 166 may incorporate at least a portion of the user information and the persona information to generate a portion of the solution configured to be understood by the user (e.g., by generating each solution stage using a vocabulary understood by the user). Alternatively, the solution generation module 166 may generate a solution plan which may not incorporate user information or persona information during generation of some, or all, of the portions of the solution plan. The solution generation module 166 or the personalized assistant module 162 may then modify some or all of the portions of the solution plan based on user information or persona information.

For example, a solution plan may be generated by the solution generation module 166 using terminology found in one or more information sources (e.g., the environment information system 130). The solution generation module 166 or the personalized assistant module 162 may then modify the solution plan, such as by replacing words with terminology associated with the persona associated with the user. Additionally, the solution generation module 166 or the personalized assistant module 162 may retrieve additional information, which may be useful in guiding the user to enact the solution plan, and incorporate such retrieved additional information into a modified solution plan to be provided to the user. In one example, the solution generation module 166 may generate a solution plan in textual form designed to guide the user in repairing a piece of equipment as part of the user's job. The solution generation module 166 may then determine that the user information indicates the user has recently begun their job, and so is unlikely to have experience with the piece of equipment to be repaired. The solution generation module 166 may then retrieve additional information for the user to improve the user's understanding of the solution, for example a training video containing instructions for interacting with the equipment, and provide the additional information as part of the solution plan.

The persona information store 168 is configured to store persona information for use by the personalized assistance system 160 in determining a persona to be associated with a user, or in generating a solution plan for the user based in part on the persona associated with the user. Additionally, the persona information store 168 may store previously generated persona information and may further store an association between the previously generated persona information and the user. In some embodiments, persona information may be applicable to a plurality of users, and the persona information store 168 may store information indicating which users may be associated with the persona information or information useful for determining a user may be associated with the persona information.

The contextual information system 120 may be a system in communication with one or more data stores configured to store various information accessible by the personalized assistance system 160 based on the context of the request to which the personalized assistance system 160 is responding. For example, the contextual information system 120 may be in communication with a data store containing previous requests received by the personalized assistance system 160, or a list of terms commonly associated with a user, job, educational level, or environment associated with the request. The previous requests may be associated with metadata indicating a user associated with the request, a requesting system 110 associated with the request, a persona associated with the request, an equipment associated with the request, a device associated with the request, or an issue associated with the request. Additionally, a data store in communication with the contextual information system 120 may store information associated with a location from which the request was received, or a time of day the request was received. Data stores in communication with the contextual information system 120 may further store information indicating a machine learning model of the model store 165 previously used to respond to a request, and may associate machine learning models with request types, user types, personas, and the like.

The environment information system 130 may be a computing system in communication with one or more data stores configured to store information associated with the environment of the user. For example, where the user is an employee in a job environment, the environment information system 130 may be in communication with a data store associated with an employer. A data store associated with the employer may store job information (e.g., an experience level associated with job positions, types of job positions, definitions for job titles, etc.). Additionally, a data store associated with the employer may store employer information including, but not limited to, an industry in which the employer operates, job site location information (e.g., a location of a warehouse, a location of an office, a location of a current job site, etc.), equipment associated with the employer, devices associated with the employer, maintenance logs, employee assignments, user manuals, supplier information, and internally maintained documents (e.g., employment policies, training materials, etc.). Additionally, a data store associated with the employer may store previous requests provided to the personalized assistance system 160 by users of systems or devices under the control of the employer, or when the personalized assistance system 160 is under the control of the employer. Previous request information may be modified (e.g., encrypted, anonymized, etc.) such that an individual employee is not associated with the request. It should be understood that references to employers and employment generally are used herein to simplify description of the environment information system 130, and that the environment information system 130 may store information about any environment in which the personalized assistance system 160 may be used.

The user information system 140 may be in communication with one or more data stores containing attributes or role information for users of the user information system 140 which has been voluntarily provided by the associated user based on informed consent. User information may refer to information unique to a user, which may be further generalized during the generation, or retrieval, of persona information for the user. Role information may be provided by an employer, or by the user, and may indicate attributes associated with a role (e.g., a list of qualifications for a job position, a job posting for a job position, an employee handbook indicating role information, etc.). In some embodiments, user attributes may additionally include information which the user chooses to consent to provide, such as a previous employment history, an educational history, languages spoken, a length of employment, a current job position, additional credentials for which the user has qualified, a technical background, or other attributes associated with the user.

The model store 165 is a data storage location configured to store one or more machine learning models for use by the personalized assistance system 160. The model store 165 may store one or more machine learning models to be used by the persona generation module 164, and configured to determine a persona of a user who has generated a request for the personalized assistance system 160. The model store 165 may further store one or more machine learning models configured to be used by the solution generation module 166 to generate a solution plan. Additionally, the model store 165 may store one or more machine learning models used by the personalized assistant module 162 to parse an incoming request received from a requesting system 110, and one or more machine learning models configured to modify a solution plan generated by the solution generation module 166, based on persona or user information, to provide a personalized solution plan in response to the request received from the user.

In some embodiments, the model store 165 may further store one or more machine learning models which will be trained by the personalized assistance system 160 to generate or provide a function described herein. For example, the model store 165 may store a large language model which has been previously trained in a general manner based on a large corpus of text from a variety of sources. The personalized assistance system 160 may then retrieve the large language model and modify the large language model through training by providing information from the environment information system 130 to improve the quality or relevance of solution plans generated by the personalized assistance system 160. Additionally, the personalized assistance system 160 may retrieve the large language model and modify the large language model through training by providing information from the persona information store 168 to improve the ability of the modified large language model to determine a persona.

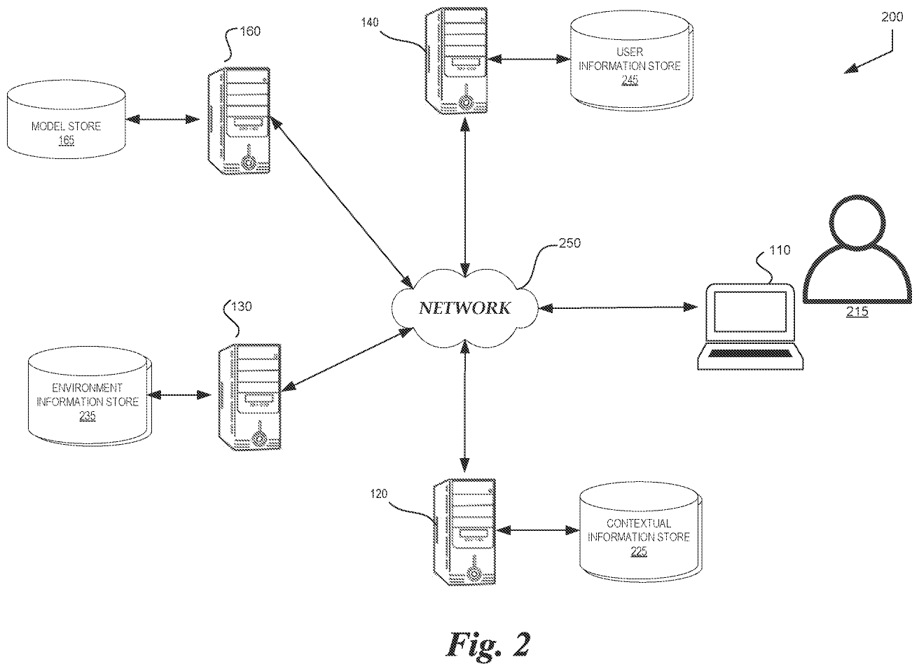

With reference to an illustrative example, FIG. 2 shows an environment 200 for providing personalized assistance to a user. The environment 200 includes a requesting system 110 associated with a user 215, a contextual information system 120, an environment information system 130, a user information system 140, a personalized assistance system 160, and a network 250.

The requesting system 110 is described above with reference to FIG. 1 and is associated with the user 215. The user 215 may be, for example, an employee, a guest, or a customer having an association with the environment 200. The user 215 provides the request for a solution to be generated by the personalized assistance system 160.

The contextual information system 120 is described above with reference to FIG. 1 and is in communication with a contextual information store 225. The contextual information store 225 may be one or more information storage locations configured to store contextual information as described above.

The environment information system 130 is described above with reference to FIG. 1 and is associated with an environment information store 235. The environment information store 235 may be one or more information storage locations configured to store environment information as described above.

The user information system 140 is described above with reference to FIG. 1 and is in communication with a user information store 245. The user information store 245 may be one or more information storage locations configured to store information voluntarily provided by one or more users of the personalized assistance system 160 in order to provide improved response information in a solution plan. Additionally, the information stored by the user information system 140 may be stored in a manner that is more secure than other information storage locations of the environment 200 to ensure user privacy and security of user information. Additionally, the user information system 140 may allow for users to delete information associated with the user stored in a user information store 245.

The network 250 may be a publicly-accessible network of linked networks, some or all of which may be operated by various distinct parties, for example the Internet. In some cases, network 250 may include a private network, personal area network, local area network, wide area network, cellular data network, satellite network, etc., or some combination thereof, some or all of which may or may not have access to and/or from the Internet.

### Example Personalized Solution Preparation and Generation Routines

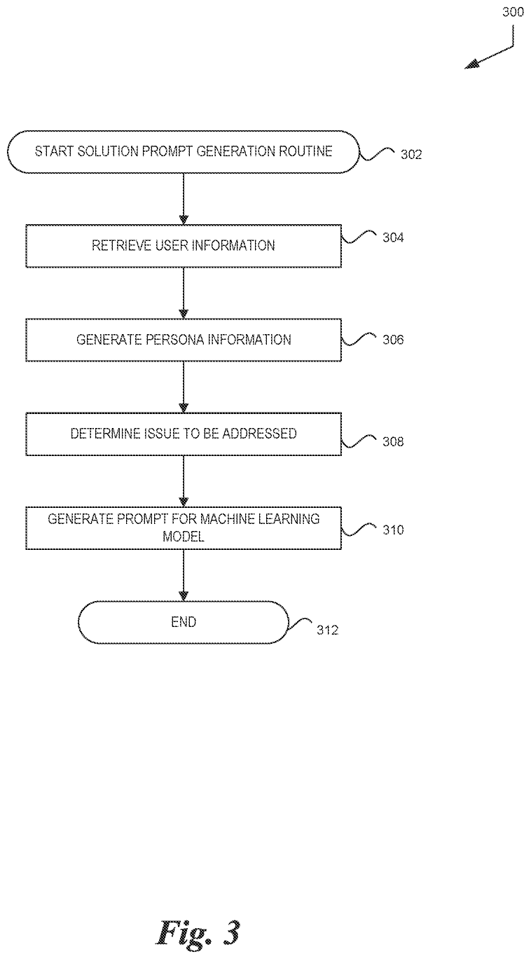

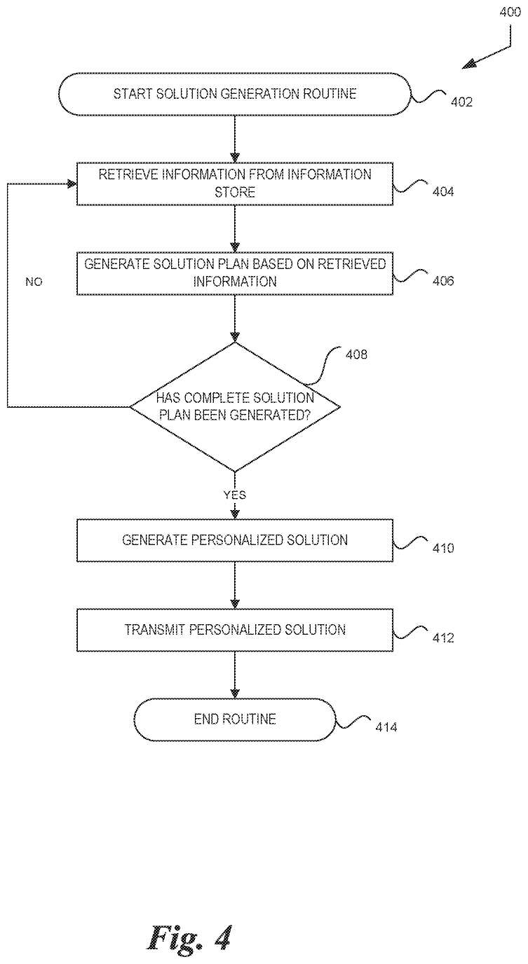

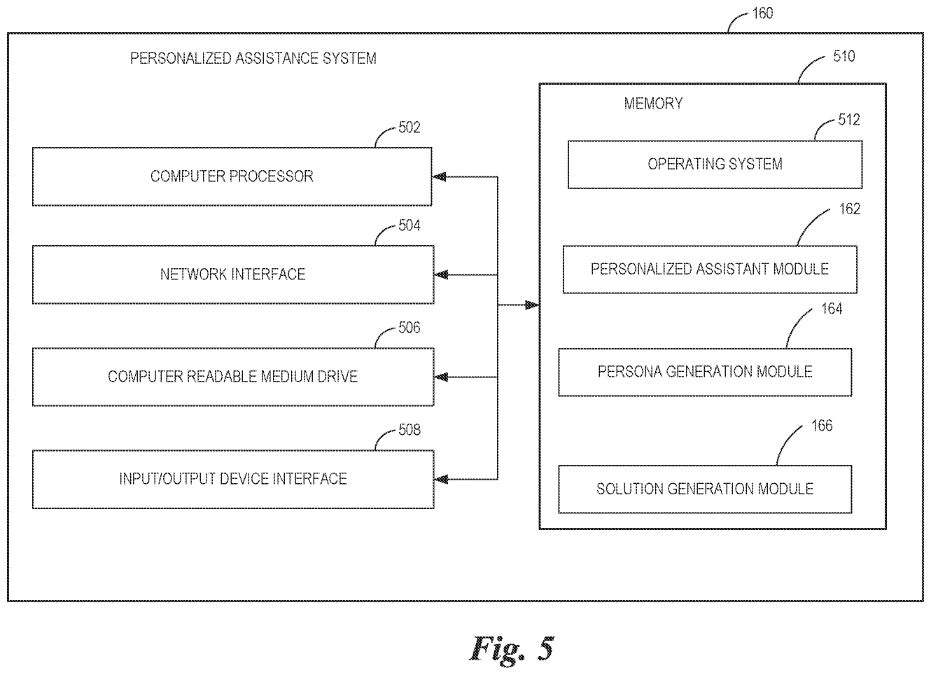

When a routine described herein (e.g., routines 300 and 400 shown in FIGS. 3 and 4 respectively) is initiated, a set of executable program instructions stored on one or more non-transitory computer-readable media (e.g., hard drive, flash memory, removable media, etc.) may be loaded into memory (e.g., random access memory or RAM) of a computing device, such as the memory of the personalized assistance system 160 shown in FIG. 5, and executed by one or more processors. In some embodiments, the routine 300, routine 400, or portions thereof may be implemented on multiple processors, serially or in parallel.

FIG. 3 illustrates example routine 300 for generating a solution prompt for a machine learning model. The routine 300 begins at block 302, for example in response to the personalized assistance system 160 receiving a request from a requesting system 110 in the form of a question to be answered for a user 215.

At block 304, the personalized assistance system 160 retrieves user information associated with the user 215. For example, the request may include information, such as a user identifier, indicating an identity of the user 215. Alternatively, a graphical user interface for accessing the personalized assistance system 160, for example provided via the requesting system 110, may include the ability for the user 215 to provide user identification information. Based on the user identification information, the personalized assistant module 162 of the personalized assistance system 160 may transmit a user information request for information associated with the user from the user information system 140. In response to the user information request, the user information system 140 may access a user information store 245 containing the requested user information. In some embodiments, such as where personal information associated with the user is stored in a user information store 245, the personalized assistant module 162 may prompt the user 215 to confirm that the personalized assistance system 160 has permission to access the user information stored in the user information store 245. For example, the user 215 may be prompted, via a graphical user interface presented by the requesting system 110, to enter a password, or to otherwise indicate that permission is being provided to access the user information store 245 to retrieve user information for the limited purpose of generating a personalized solution plan. Further, the personalized assistant module 162 may request information associated with the user from the environment information system 130.

At block 306, the personalized assistance system 160 generates persona information associated with the user 215. To generate the persona information, the persona generation module 164 may process retrieved user information. Examples of user information the persona generation module 164 may use to generate the persona information include, but are not limited to, a user type (e.g., employee, visitor, customer, etc.), a user's job position (e.g., junior engineer, senior sales associate, accounts manager, etc.), a job type (e.g., workshop floor, assembly, marketing, management, engineering, visual design, etc.), a seniority level of the user (e.g., a number of months in a current job position, a number of years as an employee of the employer, etc.), voluntarily provided user information (e.g., an education level, a previous employer, etc.), and the like. The persona generation module 164 may additionally use information related to the environment, for example environment information retrieved from the environment information system 130, to generate the persona information. For example, the persona generation module 164 may retrieve from the environment information system 130 an equipment list, an equipment manual, spatial information (e.g., a map, a relative location of an object, a distance between points within the environment, a location of the user environment, etc.), an output of a location (e.g., a manufactured object, a design, a writing type, etc.), requests previously received by the personalized assistance system 160 from users in a same or similar environment, employer internal information (e.g., company handbooks, equipment manuals, maintenance logs, etc.), or any other information associated with the environment associated with the request. Further, the persona generation module 164 may retrieve contextual information from the contextual information system 120 to generate the persona information. For example, the persona generation module 164 may retrieve from the contextual information system 120 a set of commonly used terms associated with a job type or job position, a set of terms based on a voluntarily provided educational information of the user, previously received requests from additional environments, an identification of a machine learning model used to generate previous persona information, or other contextual information useful for generating persona information for the request.

Based on the information retrieved, the persona generation module 164 may generate persona information for the user 215 associated with the request. The persona information may then be used, for example, in the generation of the response generated by the solution generation module 166, or to customize the generated solution for the user 215. When persona information is generated by the persona generation module 164, the persona generation module 164 may store the generated persona information for future use. In some embodiments, the persona generation module 164 may search a persona information store 168 for previously generated persona information which may be applicable to the user 215. For example, the persona generation module 164 may identify and retrieve previously generated persona information based on user information associated with the user 215. Retrieving previously generated persona information may allow for more efficient generation of solutions by the personalized assistance system 160, by minimizing the time needed to generate persona information for each request. As the personalized assistance system 160 is used, additional persona information is generated, potentially reducing the need to generate new persona information for received requests.

At block 308, the personalized assistance system 160 determines, based on the request, an issue to be addressed through the generation of a solution. Additionally, to determine the issue to be addressed, the personalized assistant module 162 may further use at least a portion of the retrieved user information or the generated persona information. The issue to be addressed may be determined by the personalized assistant module 162 using a rules-based system, for example by parsing the request to identify terms likely to indicate an issue. Alternatively, the issue to be addressed may be determine by the personalized assistant module 162 based on applying a prompt, as input to a machine learning model configured to provide an identification of an issue as output. The prompt generated by the personalized assistant module 162 may be based at least in part on the request, user information, or persona information.

At block 310, the personalized assistance system 160 generates the prompt to be provided to the machine learning model as input to cause the machine learning model to generate the solution to the request received from the requesting system 110. When the personalized assistant module 162 has generated the prompt, the routine 300 moves to block 312 and ends.

FIG. 4 illustrates example routine 400 for generating a personalized solution for a user 215 using a machine learning model. The routine 400 begins at block 402, for example in response to the personalized assistance system 160 receiving, or generating, a prompt configured to cause a machine learning model to generate a solution for the user 215. The prompt may be generated by the personalized assistance system 160 as described above in relation to FIG. 3. As described previously herein, the prompt may include at least a portion of a request from a user 215, user information from a user information system 140, environmental information from an environment information system 130, contextual information from a contextual information system 120, or an indication of a location of such information. Additionally, the prompt may include an indication of a machine learning model stored by the model store 165 to be used by the solution generation module 166 when generating a solution plan.

At block 404, the personalized assistance system 160 retrieves information which may be used in the generation of a solution plan from an information store. In some embodiments, the prompt may be provided to a machine learning model of the solution generation module 166. The machine learning model may generate a request for information, based on the prompt, which indicates an information store from which to retrieve the information. The personalized assistance system 160 may transmit the request for information to the indicated information store to retrieve the information. Alternatively, the prompt may include an indication of an information store where information which may be useful in the generation of the solution plan is stored. For example, the prompt may indicate that equipment information is stored in an environment information store 235. The personalized assistance system 160 may retrieve the information from the indicated environment information store 235 and provide the information as part of an input to the machine learning model of the personalized assistance system 160. Alternatively, the personalized assistance system 160 may generate a request to retrieve the information from the indicated environment information store 235. In another alternative, the prompt may include the information, and the routine 400 may skip block 404.

At block 406, the personalized assistance system 160 generates a solution plan, based at least in part on the retrieved information. In some embodiments, the solution plan may be a general solution plan, which has not been personalized for a user 215. In such embodiments, the personalized assistance system 160 may generate a solution request prompt for a machine learning model retrieved from the model store 165. The generation of the solution request prompt of such embodiments may include environmental information or contextual information. User information may be provided as part of the solution request prompt, but the amount of user information provided may be reduced, or different types of user information may be provided, as compared to embodiments where the solution generation is personalized. The personalized assistance system 160 may provide the solution request prompt as input to the machine learning model to cause the generation of at least a portion of the solution plan. In alternative embodiments, the solution plan may be a personalized solution plan. In such embodiments, the personalized assistance system 160 may generate a solution request prompt which includes a combination of environment information or contextual information, and user information. The solution request prompt of such embodiments may be configured to cause the machine learning model to generate at least a portion of a personalized solution plan. For example, a portion of a solution plan may use technical language identified by the machine learning model in technical documents used to generate the portion of the solution plan. However, a personalized portion of the solution plan may be generated based in part on an indication the user 215 is new to a job, and the personalized portion of the solution plan may be generated where technical language of the technical documents is replaced by simplified explanations more likely to be understood by the user 215 without the need to consult additional references. In some cases, the personalized assistance system 160 may update at least a portion of a previously generated solution plan, for example when a determination is made that the previously generated solution plan was not fully responsive to the request received from the user 215.

At decision block 408, the personalized assistance system 160 determines whether a complete solution plan has been generated. For example, a machine learning model of the personalized assistance system 160 may be used to compare a generated solution plan with the issue indicated in the initial prompt. If the solution plan is determined to be complete, for example to be likely to provide a solution to the issue indicated in the prompt, the routine 400 moves to block 410. Otherwise, if the solution plan is determined not to be complete, the routine 400 may return to block 404, or block 406, to continue generation of the solution plan.

At block 410, the personalized assistance system 160 generates a user-specific, or personalized, solution plan. As discussed previously herein with respect to block 406, in some embodiments, the solution plan generated by the personalized assistance system 160 is personalized during the course of generation. In such embodiments, the routine 400 may skip block 410.

Where the solution plan generated by the solution generation module 166 is a general solution plan, or at least a portion of the solution plan is general and not personalized for the user 215, the personalized assistance system 160 may personalize the solution plan. For example, the personalized assistance system 160 may retrieve a machine learning model from the model store 165. The machine learning mode may be retrieved, for example, based in part on the persona associated with the user 215 (e.g., based on a language spoken by the user 215 indicated by the persona). The personalized assistance system 160 may generate a personalization prompt for the machine learning model. The personalization prompt may include at least a portion of the solution plan, information retrieved from the user information system 140, environmental information retrieved from the environment information system 130, or contextual information retrieved from the contextual information system 120. The personalization prompt may further include information in the initial prompt which caused initiation of the routine 400. The personalized assistance system 160 may then provide the personalization prompt as input to the machine learning model, causing the machine learning model to generate at least a portion of the personalized solution plan. The personalized assistance system 160 may continue to provide information and portions of the solution plan until a complete personalized solution plan is generated. In some cases, the personalized solution plan may include more, or fewer, portions than the solution plan from which it was generated. For example, additional steps may be included as portions of the personalized solution plan in order to further explain a concept or action to a user, which may simplify the performance or understanding of the solution plan by the user.

At block 412, the personalized assistance system 160 transmits, or causes transmission of, the user-specific solution generated by the machine learning model to the user. For example, the personalized assistance system 160 may transmit the user-specific solution to a requesting system 110 associated with the user. When the personalized assistance system 160 has transmitted the user-specific solution to the user, the routine 400 moves to block 414 and ends.

### Execution Environment

FIG. 5 illustrates various components of an example personalized assistance system 160 configured to implement various functionality described herein.

In some embodiments, the personalized assistance system 160 may be implemented using any of a variety of computing devices, such as server computing devices, desktop computing devices, personal computing devices, mobile computing devices, mainframe computing devices, midrange computing devices, host computing devices, or some combination thereof.

In some embodiments, the features and services provided by the personalized assistance system 160 may be implemented as web services consumable via one or more communication networks. In further embodiments, the personalized assistance system 160 is provided by one or more virtual machines implemented in a hosted computing environment. The hosted computing environment may include one or more rapidly provisioned and released computing resources, such as computing devices, networking devices, and/or storage devices. A hosted computing environment may also be referred to as a “cloud” computing environment.

In some embodiments, as shown, a personalized assistance system 160 may include: one or more computer processors 502, such as physical central processing units (“CPUs”); one or more network interfaces 504, such as a network interface cards (“NICs”); one or more computer readable medium drives 506, such as a high density disk (“HDDs”), solid state drives (“SSDs”), flash drives, and/or other persistent non-transitory computer readable media; one or more input/output device interfaces 508; and one or more computer-readable memories 510, such as random access memory (“RAM”) and/or other volatile non-transitory computer readable media.

The computer-readable memory 510 may include computer program instructions that one or more computer processors 502 execute and/or data that the one or more computer processors 502 use in order to implement one or more embodiments. For example, the computer-readable memory 510 can store an operating system 512 to provide general administration of the personalized assistance system 160. As another example, the computer readable memory 510 can store a personalized assistant module 162. As another example, the computer-readable memory 510 can store a persona generation module 164. As another example, the computer-readable memory 510 can store a solution generation module 166.

### Terminology

All of the methods and tasks described herein may be performed and fully automated by a computer system. The computer system may, in some cases, include multiple distinct computers or computing devices (e.g., physical servers, workstations, storage arrays, cloud computing resources, etc.) that communicate and interoperate over a network to perform the described functions. Each such computing device typically includes a processor (or multiple processors) that executes program instructions or modules stored in a memory or other non-transitory computer-readable storage medium or device (e.g., solid state storage devices, disk drives, etc.). The various functions disclosed herein may be embodied in such program instructions, or may be implemented in application-specific circuitry (e.g., ASICs or FPGAs) of the computer system. Where the computer system includes multiple computing devices, these devices may, but need not, be co-located. The results of the disclosed methods and tasks may be persistently stored by transforming physical storage devices, such as solid-state memory chips or magnetic disks, into a different state. In some embodiments, the computer system may be a cloud-based computing system whose processing resources are shared by multiple distinct business entities or other users.

Depending on the embodiment, certain acts, events, or functions of any of the processes or algorithms described herein can be performed in a different sequence, can be added, merged, or left out altogether (e.g., not all described operations or events are necessary for the practice of the algorithm). Moreover, in certain embodiments, operations or events can be performed concurrently, e.g., through multi-threaded processing, interrupt processing, or multiple processors or processor cores or on other parallel architectures, rather than sequentially.

The various illustrative logical blocks, modules, routines, and algorithm steps described in connection with the embodiments disclosed herein can be implemented as electronic hardware, or combinations of electronic hardware and computer software. To clearly illustrate this interchangeability, various illustrative components, blocks, modules, and steps have been described above generally in terms of their functionality. Whether such functionality is implemented as hardware, or as software that runs on hardware, depends upon the particular application and design conditions imposed on the overall system. The described functionality can be implemented in varying ways for each particular application, but such implementation decisions should not be interpreted as causing a departure from the scope of the disclosure.

Moreover, the various illustrative logical blocks and modules described in connection with the embodiments disclosed herein can be implemented or performed by a machine, such as a processor device, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A processor device can be a microprocessor, but in the alternative, the processor device can be a controller, microcontroller, or state machine, combinations of the same, or the like. A processor device can include electrical circuitry configured to process computer-executable instructions. In another embodiment, a processor device includes an FPGA or other programmable device that performs logic operations without processing computer-executable instructions. A processor device can also be implemented as a combination of computing devices, e.g., a combination of a DSP and a microprocessor, a plurality of microprocessors, one or more microprocessors in conjunction with a DSP core, or any other such configuration. Although described herein primarily with respect to digital technology, a processor device may also include primarily analog components. For example, some or all of the algorithms described herein may be implemented in analog circuitry or mixed analog and digital circuitry. A computing environment can include any type of computer system, including, but not limited to, a computer system based on a microprocessor, a mainframe computer, a digital signal processor, a portable computing device, a device controller, or a computational engine within an appliance, to name a few.

The elements of a method, process, routine, or algorithm described in connection with the embodiments disclosed herein can be embodied directly in hardware, in a software module executed by a processor device, or in a combination of the two. A software module can reside in RAM memory, flash memory, ROM memory, EPROM memory, EEPROM memory, registers, hard disk, a removable disk, a CD-ROM, or any other form of a non-transitory computer-readable storage medium. An exemplary storage medium can be coupled to the processor device such that the processor device can read information from, and write information to, the storage medium. In the alternative, the storage medium can be integral to the processor device. The processor device and the storage medium can reside in an ASIC. The ASIC can reside in a user terminal. In the alternative, the processor device and the storage medium can reside as discrete components in a user terminal.

Conditional language used herein, such as, among others, “can,” “could,” “might,” “may,” “e.g.,” and the like, unless specifically stated otherwise, or otherwise understood within the context as used, is generally intended to convey that certain embodiments include, while other embodiments do not include, certain features, elements and/or steps. Thus, such conditional language is not generally intended to imply that features, elements and/or steps are in any way required for one or more embodiments or that one or more embodiments necessarily include logic for deciding, with or without other input or prompting, whether these features, elements and/or steps are included or are to be performed in any particular embodiment. The terms “comprising,” “including,” “having,” and the like are synonymous and are used inclusively, in an open-ended fashion, and do not exclude additional elements, features, acts, operations, and so forth. Also, the term “or” is used in its inclusive sense (and not in its exclusive sense) so that when used, for example, to connect a list of elements, the term “or” means one, some, or all of the elements in the list.

Disjunctive language such as the phrase “at least one of X, Y, Z,” unless specifically stated otherwise, is otherwise understood with the context as used in general to present that an item, term, etc., may be either X, Y, or Z, or any combination thereof (e.g., X, Y, and/or Z). Thus, such disjunctive language is not generally intended to, and should not, imply that certain embodiments require at least one of X, at least one of Y, or at least one of Z to each be present.

Unless otherwise explicitly stated, articles such as “a” or “an” should generally be interpreted to include one or more described items. Accordingly, phrases such as “a device configured to” are intended to include one or more recited devices. Such one or more recited devices can also be collectively configured to carry out the stated recitations. For example, “a processor configured to carry out recitations A, B and C” can include a first processor configured to carry out recitation A working in conjunction with a second processor configured to carry out recitations B and C.

While the above detailed description has shown, described, and pointed out novel features as applied to various embodiments, it can be understood that various omissions, substitutions, and changes in the form and details of the devices or algorithms illustrated can be made without departing from the spirit of the disclosure. As can be recognized, certain embodiments described herein can be embodied within a form that does not provide all of the features and benefits set forth herein, as some features can be used or practiced separately from others. The scope of certain embodiments disclosed herein is indicated by the appended claims rather than by the foregoing description. All changes which come within the meaning and range of equivalency of the claims are to be embraced within their scope.

1. A system comprising:
a computer-readable memory storing computer-executable instructions and a plurality of machine learning models; and
one or more processors configured to execute the computer-executable instructions to at least:
receive, from a requesting device, a request to generate a solution plan comprising an indication of a user identity associated with a user;
obtain, based at least in part on the request, user information from a user information store, wherein the user information indicates an attribute or role information associated with the user;
obtain, based at least in part on the request, environment information from an environmental information store, wherein the environment information comprises information describing an environment for which the solution plan is to be generated;
determine, based at least in part on the user information, a persona corresponding to a group of the user;
generate, based at least in part on the request, the user information, the environment information, and the persona, a solution generation prompt configured to cause a machine learning model of the plurality of machine learning models to generate a personalized solution plan;
generate the personalized solution plan based on applying the solution generation prompt as input to the machine learning model; and
cause the requesting device to present the personalized solution plan to the user.

2. The system of claim 1, wherein the one or more processors are further configured by the computer-executable instructions to obtain, based at least in part on the request, contextual information from a contextual information store, wherein the contextual information comprises a previous request received by the system, and wherein the solution plan is further based in part on the contextual information.

3. The system of claim 1, wherein to generate the persona, the one or more processors are further configured by the computer-executable instructions to:
generate a persona generation prompt configured to cause a second machine learning model to generate the persona; and
apply the persona generation prompt as input to the second machine learning model.

4. The system of claim 1, wherein the one or more processors are further configured by the computer-executable instructions to determine the personalized solution plan is responsive to the request based on applying the solution plan as input to a second machine learning model configured to generate a determination indicating whether the personalized solution plan is responsive to the request.

5. A computer-implemented method comprising:
under control of a computing device comprising one or more processors configured to execute specific instructions,
receiving a request to generate a personalized solution plan comprising an indication of a user identity corresponding to a user;
obtaining user information associated with the user identity;
determining, based on the obtained user information, a persona associated with the user;
generating, based in part on the request and the persona, a solution request prompt;
generating the personalized solution plan based at least in part on applying the solution request prompt as input to a machine learning model configured to generate a solution plan; and
causing transmission of the personalized solution plan responsive to the request.

6. The computer-implemented method of claim 5 further comprising obtaining environment information, wherein the persona is determined based in part on the environment information.

7. The computer-implemented method of claim 5 further comprising obtaining contextual information, wherein the persona is determined based in part on the contextual information.

8. The computer-implemented method of claim 5, wherein to generate the personalized solution plan the machine learning model further obtains environment information, and wherein the personalized solution plan is based at least in part on the environment information.

9. The computer-implemented method of claim 5, wherein to generate the personalized solution plan the machine learning model further obtains contextual information, and wherein the personalized solution plan is based at least in part on the contextual information.

10. The computer-implemented method of claim 5 further comprising:
applying the personalized solution plan as input to a second machine learning model configured to generate a determination indicating whether the personalized solution plan is responsive to the request;
based on the determination indicating the personalized solution plan is not responsive to the request, obtaining additional information; and
updating the personalized solution plan based at least in part on applying the personalized solution plan and the additional information as input to the machine learning model.

11. The computer-implemented method of claim 5 further comprising modifying the personalized solution plan based on applying the persona and the personalized solution plan as input to a second machine learning model configured to further personalize the personalized solution plan for the user identity.

12. The computer-implemented method of claim 11, wherein the personalized solution plan comprises a plurality of solution instructions, and wherein further personalizing the solution plan comprises at least one of: replacing a first term of a text of the solution plan with a second term based in part on the persona, adding an additional solution instruction to the plurality of solution instructions of the solution plan, or removing a solution instruction of the plurality of solution instructions of the solution plan.

13. A non-transitory machine-readable storage medium encoded with instructions executable by a processor of a computing device, wherein the instructions, when executed by the processor, cause the computing device to at least:
receive a request comprising an indication of a user identity;
obtain user information associated with the user identity;
determine, based on the obtained user information, a persona;
generate, based in part on the request and the persona, a solution request prompt;
generate a personalized solution plan based at least in part on applying the solution request prompt as input to a machine learning model configured to generate a solution plan; and
provide the personalized solution plan in response to the request.

14. The non-transitory machine-readable storage medium of claim 13, wherein the instructions, when executed by the processor, further cause the computing device to:
obtain environmental information for an environment associated with the request; and
obtain contextual information based in part on the request;
wherein the solution request prompt is generated based in part on the environmental information and the contextual information.

15. The non-transitory machine-readable storage medium of claim 14, wherein the environmental information comprises at least one of: an equipment identifier, a device identifier, or a user location.

16. The non-transitory machine-readable storage medium of claim 14, wherein the contextual information comprises at least one of: a previous request, a previous personalized solution plan, or a previous machine learning model used to generate the previous personalized solution plan.

17. The non-transitory machine-readable storage medium of claim 13, wherein the personalized solution plan comprises a plurality of solution instructions.

18. The non-transitory machine-readable storage medium of claim 17, wherein each solution instruction of the plurality of solution instructions comprise at least one of: a text instruction, a video instruction, an image instruction, or a multimodal instruction.

19. The non-transitory machine-readable storage medium of claim 13, wherein the user information comprises at least one of: a job position, a length of employment, an employer, or a technical background.

20. The non-transitory machine-readable storage medium of claim 13, wherein the machine learning model is retrieved from a machine learning model store based in part on the solution request prompt.
